(19) United States
(12) Patent Application Publication
(10) Pub. No.: US 2003/0176941 A1
(43) Pub. Date: Sep. 18, 2003

(54) Simultaneous starting apparatus of positioning decision module and method therefor

(75) Inventor: Seong-Beom Park, Anyang (KR)

Correspondence Address: GREENBLUM & BERNSTEIN, P.L.C., 1950 ROLAND CLARKE PLACE, RESTON, VA, 20191, US

(73) Assignee: LG Industrial Systems Co., Ltd., Seoul (KR)

(21) Appl. No.: 10/386,674

(22) Filed: Mar. 13, 2003

(30) Foreign Application Priority Data
Mar. 14, 2002 (KR) 13917/2002

(51) Int. Cl. G05B 19/18

(52) U.S. Cl. 700/121

(57) ABSTRACT

A simultaneous starting apparatus of a positioning decision module and a method therefore, including an external simultaneous starting input pin for performing simultaneous starting by receiving an external simultaneous starting input signal of a “high” status from the outside under the condition that the external simultaneous starting output signal of a plurality of ASICs composed of logic circuits is a “high-impedance” status can remove time difference among orders for controlling a motor. Therefore, positioning decision processing speed among a plurality of independent positioning decision ASICs can be shortened and accordingly, the positioning decision module can become high-functional.

### BACKGROUND OF THE INVENTION

1. Field of the Invention

The present invention relates to a positioning decision module and particularly, to a simultaneous starting apparatus of a positioning decision module and a method therefor, capable of simultaneously starting a plurality of positioning decision ASICs by using an external pin in a positioning decision ASIC used in the position decision module.

2. Description of the Related Art

Generally, a positioning decision module is a module for controlling a motor on the basis of speed, acceleration and position set by a user. Conventionally, most functions of the positioning decision module were performed in a software method. However, it was difficult to apply the positioning decision module using the software method to control a high-functional motor by limitation of processing speed.

To overcome the limitation, the function of the positioning decision module could be implemented in a hardware method by using a highly integrated application specific integrated circuit (hereinafter, as ASIC). That is, the positioning decision module of the hardware method processed most high-speed response by using an exclusive ASIC which takes full charge of functions of the positioning decision module. For instance, positioning decision modules, capable of controlling output axises of a plurality of motors and performing various functions by using one positioning decision module are on sale.

However, since there is a limitation in hardware capacity that can be integrated by characteristics of the ASIC, it is difficult to achieve miniaturization and high-function of the positioning decision module. Therefore, recently, a method with which many axises can be simultaneously controlled by using a plurality of positioning decision ASICs is developed.

FIG. 1 is an exemplary view showing a simultaneous starting apparatus of the positioning decision module for controlling a motor by using two conventional positioning decision ASICs.

As shown in FIG. 1, the simultaneous starting apparatus of the positioning decision module includes a central processing unit 1 which allots addresses to first and second positioning decision ASICs and outputs a start order for controlling a motor, an address decoder 2 for selecting a predetermined number of address of the first and second positioning decision ASICs corresponding to address allotment of the central processing unit 1, a first positioning decision ASIC 3 and a second positioning decision ASIC 4 which receive a start order of the central processing unit and output a simultaneous starting signal for controlling a loading motor corresponding to a selecting signal of the address decoder 2.

The operation of the simultaneous starting apparatus of the conventional positioning decision module will be described as follows.

When a start order for controlling a motor on the basis of speed, acceleration and position set by a user is outputted from the central processing unit 1, the motor is controlled by outputting a start order through a data bus corresponding to selecting signals CS1 and CS2 of the positioning decision ASIC. That is, the central processing unit 1 allots respectively different addresses to the first and second positioning decision ASICs. Also, the address decoder 2 divides chip selecting signals into CS2 and CS2 by deciding whether the start order corresponds to the first positioning decision ASIC or the second positioning decision ASIC. Then, the central processing unit performs simultaneous starting by outputting a start order to the first and second positioning decision ASICs through a data bus corresponding to a selecting signal of the address.

However, since the order can not affect on two ASICs simultaneously in spite of a high-speed central processing unit in motor control using the two positioning decision ASICs, a time difference is inevitably generated among orders, and accordingly, it is impossible that two different ASICs are simultaneously started.

### SUMMARY OF THE INVENTION

Therefore, an object of the present invention is to provide a simultaneous starting apparatus of a positioning decision module and a method therefor, capable of simultaneously starting a plurality of positioning decision ASICs by a hardware method by using an external simultaneous starting input pin in a plurality of positioning decision ASICs used in the position decision module.

To achieve these and other advantages and in accordance with the purpose of the present invention, as embodied and broadly described herein, there is provided a simultaneous starting apparatus of a positioning decision module, including an external simultaneous starting input pin for performing simultaneous starting by receiving an external simultaneous starting input signal of a “high” status from the outside under the condition that the external simultaneous starting output signal of a plurality of ASICs composed of logic circuits is a “high-impedance” status.

To achieve these and other advantages and in accordance with the purpose of the present invention, as embodied and broadly described herein, there is provided a method for simultaneous starting a positioning decision module, including the steps of allotting numbers of address to a plurality of positioning decision ASICs through the central processing unit, determining whether values of external simultaneous starting output pin of all positioning decision ASICs are “high-impedance” corresponding to the address value, and inputting simultaneous starting signals among the plurality of ASICs through the external simultaneous starting input pin under the condition that the external simultaneous starting output pin becomes high impedance.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exemplary view showing a simultaneous starting apparatus of a positioning decision module for controlling a motor by using two conventional positioning decision ASIC.

FIG. 2 is an exemplary view showing a simultaneous starting apparatus of a positioning decision module in accordance with the present invention;

FIG. 3 is an exemplary view illustrating external simultaneous starting by using two ASICs in accordance with the present invention; and

FIG. 4 is a wave form view illustrating external simultaneous starting according to an embodiment of FIG. 3.

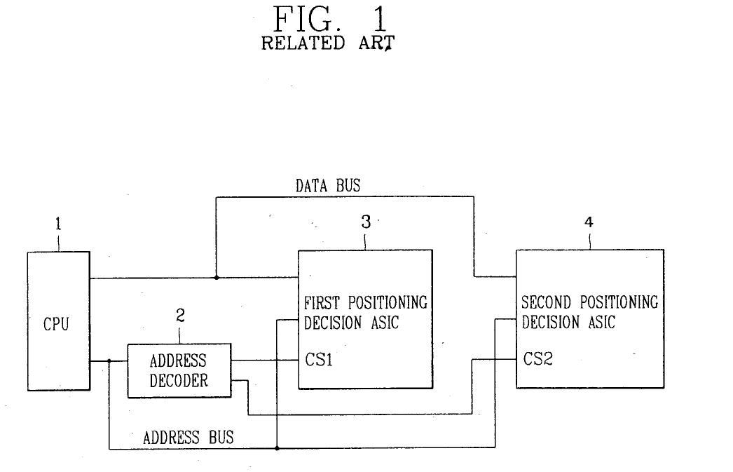

### DETAILED DESCRIPTION OF THE PREFERRED EMBODIMENTS

Reference will now be made in detail to the preferred embodiments of the present invention, examples of which are illustrated in the accompanying drawings.

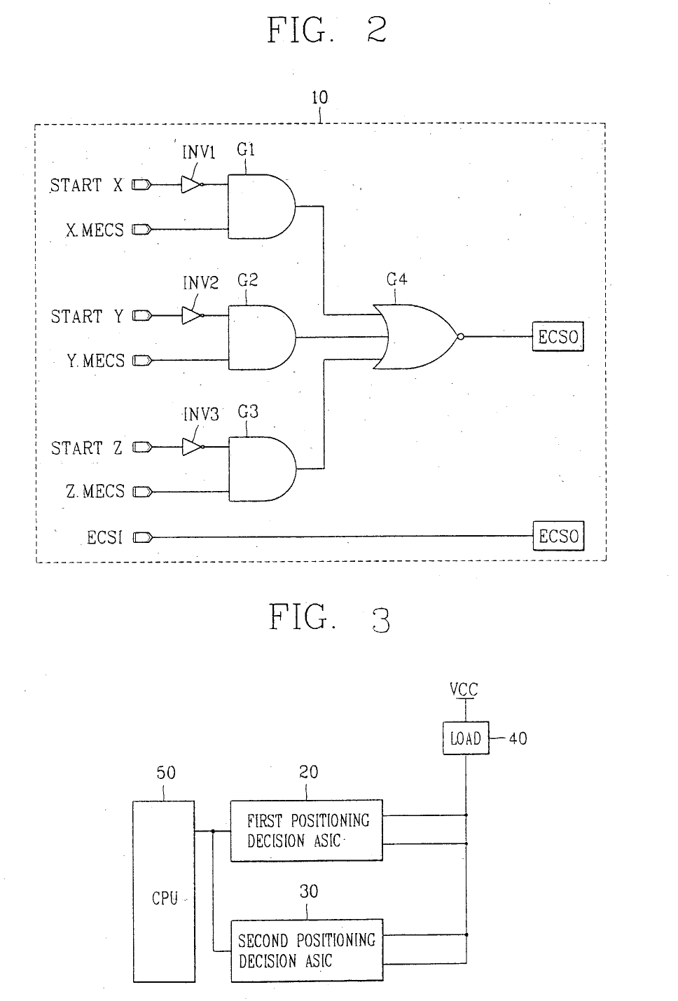

FIG. 2 is an exemplary view showing a simultaneous starting apparatus of a positioning decision module in accordance with the present invention.

As shown in FIG. 2, the simultaneous starting apparatus 10 of the positioning decision module includes a first AND gate G1 for outputting by multiplying a X-axis starting signal START X which is inverted by an inverter INV1 by a X-axis external start allowing signal X. MECS, a second AND gate G2 for outputting by multiplying a Y-axis starting signal START Y which is inverted by an inverter INV2 by a Y-axis external start allowing signal Y MECS, a third AND gate G3 for outputting by multiplying a Z-axis starting signal START Z which is inverted by an inverter INV3 by a Z-axis external start allowing signal Z. MECS, a NOR gate G4 for outputting an external simultaneous starting signal ECSO by summing and inverting signals outputted from the first, second and third AND gates G1 to G3 by receiving the signals, and an external simultaneous starting input pin ECSI for outputting an external simultaneous starting pulse for driving a motor by receiving the external simultaneous starting signal inputted from the outside.

The operation of the simultaneous starting apparatus of the positioning decision module with the above structure in accordance with the present invention will be described as follows.

Firstly, external simultaneous starting is controlled by having a region which can allow or prohibit external simultaneous starting in each axis to control respective motor axises. That is, the X-axis external start allowing signal X. MECS, the Y-axis external start allowing signal Y MECS, and the Z-axis external start allowing signal Z. MECS become values of the resistor.

Then, when a pull-up resistor is mounted outside, the status of the external simultaneous starting output pin ECSO and the external simultaneous starting is changed as follows.

When external simultaneous starting is under a ‘prohibited’ status as the values of the respective axis external start allowing signal MECS are ‘0’, the external simultaneous starting output pin ECSO becomes a high-impedance status, and the value of the external simultaneous starting input pin ECSI becomes ‘1’ by the pull-up resistance.

On the contrary, when the external simultaneous starting is under an allowed status as the values of the respective axis external start allowing signals MECSs become ‘1’, the output value of the external simultaneous starting output pin ECSO becomes ‘0’ before starting and becomes a high-impedance status after starting. Also, the value of the external simultaneous starting input pin ECSI becomes ‘0’ before starting by a pull-up resistance and becomes ‘1’ after starting.

Therefore, if the external simultaneous starting output pin ECSO of one positioning decision ASIC among a plurality of positioning decision ASICs is remained under a ‘0’ status, the external simultaneous starting input pin ECSI is read as “0” and a standby status is maintained. In a moment that the external simultaneous starting output signal ECSO of all positioning decision ASICs becomes “high-impedance”, when ‘1’ is inputted into the external simultaneous starting input pin ECSI, all axises where start orders were generated start pulse outputting, thus to simultaneously perform start orders among the position deciding ASICs.

FIG. 3 is an exemplary view illustrating external simultaneous starting by using two ASICs in accordance with the present invention.

As shown in FIG. 3, the simultaneous starting apparatus of the positioning decision module which allots an address which can allow and prohibit external simultaneous starting in each shaft to be controlled corresponding to each axis starting signal and outputs an external simultaneous starting input signal for controlling a motor, external simultaneous starting output pin ECSO of the first and second positioning decision ASICs 20 and 30 and the external simultaneous starting input pin ECSI are connected to a load 40. The load is simultaneously driven by receiving a power supply voltage VCC for driving the load. At this time, if an external simultaneous starting output pin of one positioning decision ASIC among the two positioning decision ASICs 20 and 30 is remained under a ‘0’ status, the external simultaneous starting input pin is read as ‘0’, thus to maintain a standby status, and if ‘1’ is inputted in the external simultaneous starting input pin ECSI at a moment that the external simultaneous starting output pin of all positioning decision ASICs becomes “high-impedance”, all axises where the starting orders were generated start pulse outputting, thus to simultaneously performing the starting order between the positioning determining ASICs 20 and 30.

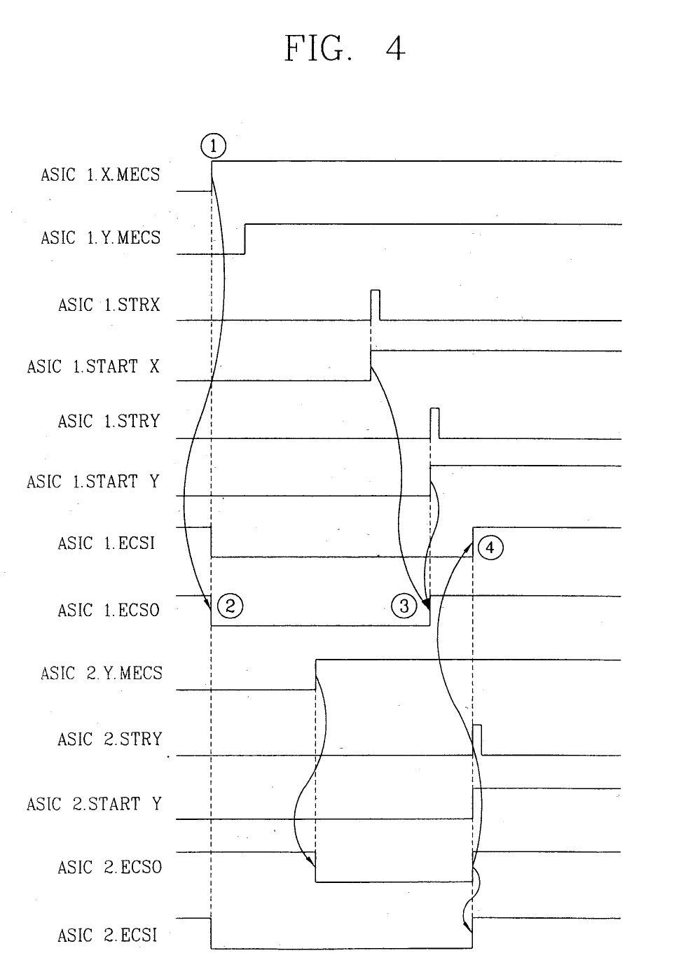

FIG. 4 is a wave form view illustrating external simultaneous starting according to an embodiment of FIG. 3.

As shown in FIG. 4, the X-axis external start allowing signal ASIC1.X. MECS becomes “1” before starting in the X axis for performing external simultaneous starting of the positioning decision ASIC (1 in FIG. 4).

The X-axis starting signal ASIC1.START X of the first positioning decision ASIC, Y-axis starting signal ASIC1.START Y and the Y-axis starting signal ASIC2, START Y of the second positioning decision ASIC are latched signals of ASIC1.STRX, ASIC1.STRY, ASIC2.STRY signals respectively inside thereof.

For instance, when there are two positioning decision ASICs, to implement simultaneous starting between the two positioning decision ASICs, if the external start allowing signal MECS of even one of the axises of the inside of the positioning decision ASIC is set as ‘1’, the output status of the external simultaneous starting output pin ASIC1.ECSO becomes 0 (2 in FIG. 4), if the two ASICs are respectively a first positioning decision ASIC and a second positioning decision ASIC.

Under the condition that all of the axises that the external start allowing signal MECS are set as ‘1’ are ordered to be started, the external simultaneous starting output pin ASIC1.ECSO becomes a ‘high-impedance’ status (3 in FIG. 4).

Under the condition that the external simultaneous starting output pin ASIC1.ECSO becomes high-impedance, when ‘1’ is inputted in the external simultaneous starting input pin ECSI by receiving the external simultaneous starting signal of a ‘high’ status by the external pull-up resistor (not shown), all axises that received the start orders start pulse outputting. At this time, if the external simultaneous starting output pin ASIC2.ECSO of other external second positioning decision ASIC is remained as ‘0’, the standby status is maintained since the simultaneous starting input pins ASIC1.ECSI, ASIC2.ECSI are read as ‘0’. Therefore, the start orders of the first and second positioning decision ASICs are simultaneously performed at a moment that the external simultaneous starting output pin of the second positioning decision ASIC becomes high-impedance (4 in FIG. 4).

As described above, since the simultaneous starting apparatus of the positioning decision module and the method therefor can output a signal for performing simultaneous starting among independent positioning decision ASICs in spite of using a plurality of positioning decision ASICs, time difference among orders for controlling a motor can be removed. Therefore, positioning decision processing speed can be shortened and accordingly, the positioning decision module can become high-functional.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. A simultaneous starting apparatus of a positioning decision module includes an external simultaneous starting input pin for performing simultaneous starting by receiving an external simultaneous starting input signal of a “high” status from the outside under the condition that the external simultaneous starting output signal of a plurality of ASICs composed of logic circuits is a “high-impedance” status.

2. The apparatus of claim 1, wherein the ASIC includes:
a plurality of AND gates for outputting a result by multiplying an axis starting signal inverted by an inverter and an axis external start allowing signal which corresponds to the axis starting signal;
a NOR gate for receiving and summing signals outputted from the plurality of AND gates and outputting the external simultaneous starting output signal by inverting; and
an external simultaneous starting input pin for receiving the external simultaneous starting input signal which is inputted from the outside.

3. The apparatus of claim 2, further comprising:
a central processing apparatus for allotting an address capable of allowing or prohibiting external simultaneous starting in each axis to be controlled corresponding to the axis starting signal, and outputting the external simultaneous starting input signal for controlling a motor.

4. The apparatus of claim 2, wherein a load is simultaneously driven by connecting the external simultaneous output pin and the external simultaneous starting input pin with the load and supplying power source voltage.

5. The apparatus of claim 2, wherein when any external simultaneous starting output pin among the plurality of positioning decision ASICs is remained as a “low” status, the external simultaneous starting input pin is read as “low”, a standby status is maintained, and starting orders are simultaneously operated among the positioning decision ASICs in a moment that the external simultaneous starting output pins of all of the positioning decision ASICs become “high-impedance”.

6. A method for simultaneous starting a positioning decision module, comprising the steps of:
allotting numbers of address to a plurality of positioning decision ASICs through a central processing unit, determining whether values of external simultaneous starting output pins of all positioning decision ASICs are “high-impedance” corresponding to the address value; and
inputting simultaneous starting signals among the plurality of ASICs through the external simultaneous starting input pin under the condition that the external simultaneous starting output pin becomes high-impedance.

7. The method of claim 6, wherein, in the step of determining whether the values of the external simultaneous starting output pins are high-impedance, when a value of any external simultaneous starting output pin among the plurality of positioning decision ASICs is remained as “low”, the value of the external simultaneous starting input pin is read as “low” and a standby status is maintained.

8. The method of claim 6, wherein the step of determining whether the values of the external simultaneous starting output pins are high-impedance includes the steps of:
outputting an output value corresponding to respective axises by multiplying an axis starting signal inverted by an inverter and an axis external start allowing signal which corresponds to the axis starting signal; and
outputting an external simultaneous starting output signal by summing and inverting the output value corresponding to the respective axises by receiving the output value.

9. The method of claim 6, wherein, in the step of inputting the simultaneous starting signal, an input value of the “high” status is inputted in the external simultaneous starting input pin through an external pull up resistor.
